(19) United States
(12) Patent Application Publication
(10) Pub. No.: US 2019/0047248 A1
(43) Pub. Date: Feb. 14, 2019

(54) Zero-CTE Quasi-Isotropic Composite Laminates With Increased Fiber Volume Percentage

(71) Applicant: Harris Corporation, Melbourme, FL (US)

(72) Inventors: James Alexander THROCKMORTON, Rochester, NY (US); Monica Lee ROMMEL, Savage, MN (US)

(21) Appl. No.: 15/674,940

(22) Filed: Aug. 11, 2017

(51) Int. Cl. B32B 5/26; B32B 5/12; C08J 5/04

(52) U.S. Cl. CPC B32B 5/26; B32B 2038/0076; C08J 5/042; B32B 5/12

(57) ABSTRACT

The present invention is directed toward a carbon fiber composite laminate with a substantially zero coefficient of thermal expansion. The carbon fiber composite laminate includes a plurality of carbon fiber plies, where the carbon fibers are unidirectional and embedded in a resin. The carbon fiber plies are stacked and oriented such that the composite laminate is quasi-isotropic. The composite laminate includes an increased fiber volume percentage (i.e., between 68.3% and 70.3%), and a substantially zero coefficient of thermal expansion.

### GOVERNMENT LICENSE RIGHTS

This invention was made with government support under USG contract No. SP4701-15-C-7004 for the U.S. Department of Defense, Defense Logistics Agency.

### BACKGROUND OF THE INVENTION

Zero thermal expansion quasi-isotropic, high-modulus carbon fiber structures are essential for creating stable structures for electro-optical telescopes. Zero thermal expansion structures are structures that contain a coefficient of thermal expansion (CTE) that is of a value at or near zero. CTE represents the degree at which an object expands in a direction with respect to a change in temperature. Typical structures or materials expand or contact depending on the change in temperature. Thus, these typical structures or materials have a CTE value above 0. Structures or materials that have CTE value at or near zero, however, do not expand or contract when experiencing changes in temperature.

Zero CTE and near zero CTE composite laminates are often utilized in the space and aerospace markets, commercial imaging systems, metrology and industrial equipment that need structures that are insensitive to temperature changes, and stability critical structures like telescopes, optical benches, and antenna structures. Zero CTE and near zero CTE composite laminates are utilized because of their high stiffness to weight ratio and high strength to weight ratio. Composite laminates are constructed of various layers or plies oriented and stacked in a predetermined pattern that is tailored or designed to meet the structural requirements of its intended purpose. Each layer of the composite laminate may consist of a reinforcing fiber, such as carbon, embedded in a resin.

Composite laminate materials, and more specifically, carbon fiber composite laminates, are one type of material that can be used to construct structures that contain zero CTE and near zero CTE properties. Carbon fibers have a negative CTE in the direction of the fiber. In general, the CTE varies with the modulus of the fiber, where the stiffer the fiber, the more negative the CTE. Conversely, resins have a positive CTE. Thus, carbon fiber laminates are able to acquire zero CTE and near zero CTE properties by balancing the negative CTE of the carbon fiber with the positive CTE of the resin. Typically, this is accomplished by a couple of methods. One method of accomplishing zero CTE and near zero CTE is with a single fiber type (i.e., a Toray M55J quasi-isotropic laminates). Another way of accomplishing 0-CTE is by blending multiple types of fiber blends (e.g., blending Toray's M40J/996 prepreg with Toray's M60J/996 prepreg) into a hybrid/blended composite laminate. With this method, by using two carbon fiber prepregs (i.e., a fibrous material preimpregnated with a particular synthetic resin) that do not naturally contain zero CTE or near zero CTE properties, the ratio between fibers can be adjusted to produce a laminate with 0-CTE or near 0-CTE properties. However, these conventional methods utilize carbon fibers that have long supply chains, making it difficult to manage cost and lead times for developing composite laminates. Furthermore, when blending carbon fibers, it becomes difficult to manage and control the characteristics of the composite laminates.

Accordingly, it would be desirable to provide a zero CTE or near zero CTE carbon fiber composite laminate that is lower in cost to manufacture compared to typical carbon fiber composite laminates, while still maintaining equivalent technical performance. Additionally, it would be desirable to provide a carbon fiber composite laminate with shorter lead times to construction. Furthermore, it would be desirable to provide a carbon fiber composite laminate that is constructed from a single fiber type, which is easier to control and characterize compared to hybrid/blended composite laminates.

### SUMMARY OF THE INVENTION

The present invention is directed toward a carbon fiber composite laminate with a substantially zero coefficient of thermal expansion (CTE). The carbon fiber composite laminate includes a plurality of carbon fiber plies, where the carbon fibers are unidirectional and embedded in a resin. The carbon fiber plies are stacked and oriented such that the composite laminate is quasi-isotropic. The composite laminate includes an increased fiber volume percentage (i.e., between 68.3% and 70.3%), and a substantially zero CTE. The composite laminate may be constructed with HM63 carbon fibers and 996 cyanate siloxane resin.

The present invention is further directed toward a method for acquiring a substantially zero CTE for a composite laminate, especially a composite laminate constructed with HM63 carbon fibers and 996 cyanate siloxane resin. The method includes setting a target fiber volume percentage, and determining a bleed scheme for the composite laminate based on the target fiber volume percentage and the materials chosen for the composite laminate. The method further includes curing the composite laminate based on the bleed scheme. Once the composite laminate is cured, the composite laminate is tested to calculate whether or not the CTE is substantially zero. In the event the composite laminate does not contain a CTE that is substantially zero, the target fiber volume percentage and the bleed scheme are modified to create a laminate with zero CTE.

### BRIEF DESCRIPTION OF THE DRAWINGS

FIG. 1A illustrates a schematic cross-sectional view of a carbon fiber laminate without an increased fiber volume percentage according to a conventional composition with a positive CTE.

FIG. 1B illustrates a schematic cross-sectional view of a carbon fiber laminate after the fiber volume percentage of the laminate has been increased according to the present invention.

FIG. 1C illustrates an optical photomicrograph cross-section of a carbon fiber laminate without an increased fiber volume percentage according to a conventional composition with a positive CTE.

FIG. 1D illustrates an optical photomicrograph cross-section of a carbon fiber laminate after the fiber volume percentage of the laminate has been increased according to the present invention.

FIG. 2 illustrates a partial perspective view of a carbon fiber laminate according to the present invention.

FIG. 3A illustrates a schematic cross-sectional view of a carbon fiber laminate according to a first layup embodiment of the present invention.

FIG. 3B illustrates a schematic cross-sectional view of a carbon fiber laminate according to a second layup embodiment of the present invention.

FIG. 3C illustrates a schematic cross-sectional view of a carbon fiber laminate according to a third layup embodiment of the present invention.

FIG. 3D illustrates a schematic cross-sectional view of a carbon fiber laminate according to a fourth layup embodiment of the present invention.

FIG. 4 illustrates a flowchart describing a method of designing a substantially zero CTE carbon fiber laminate according to the present invention.

FIG. 5 illustrates a graph of the CTE of various laminates vs. the fiber volume percentage of the various laminates according to the present invention.

Like reference numerals have been used to identify like elements throughout this disclosure.

### DETAILED DESCRIPTION OF THE INVENTION

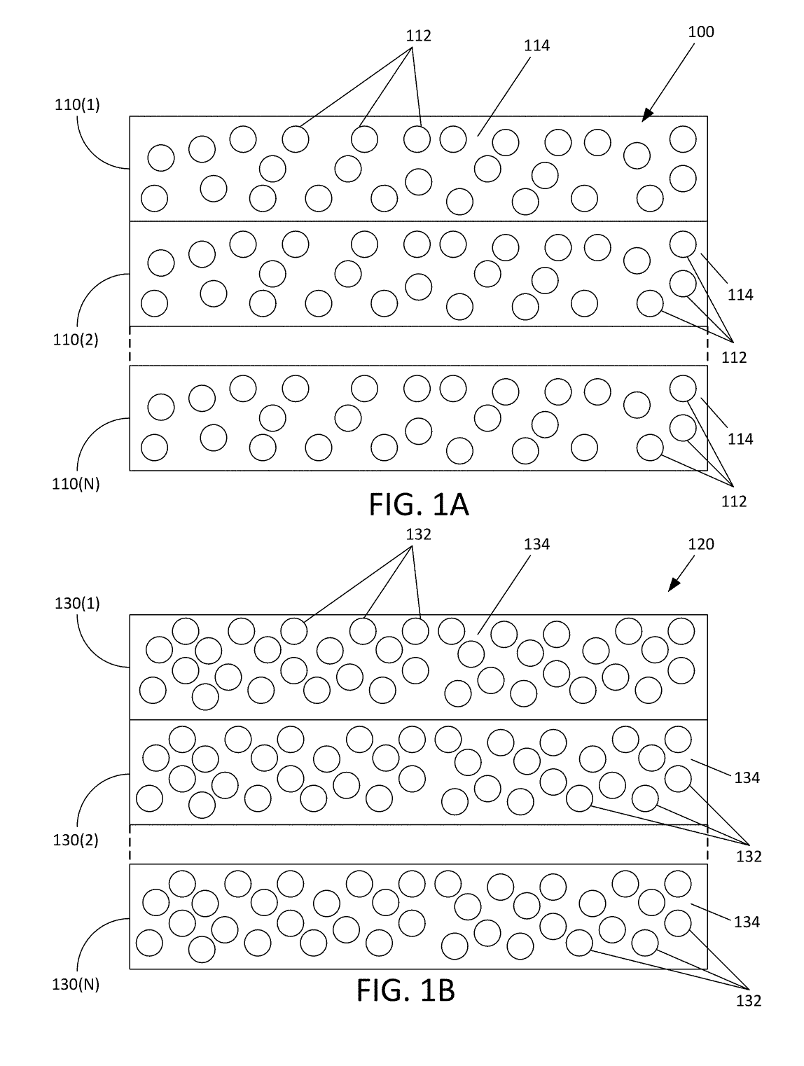

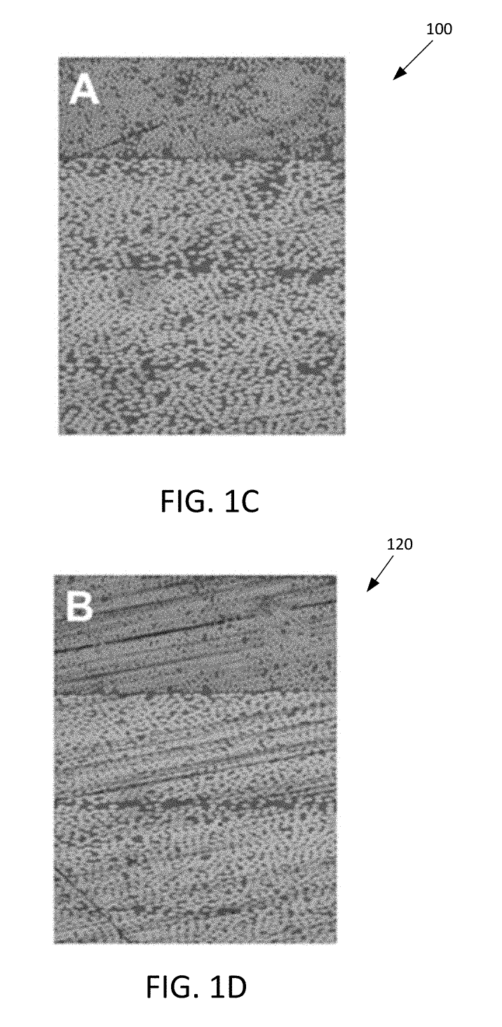

FIGS. 1A and 1B illustrate schematic diagrams of quasi-isotropic composite laminates 100, 120 constructed with carbon fibers. The composite laminate 100, illustrated in FIG. 1A is composed of a plurality of carbon fiber plies 110(1)-110(N), where the carbon fibers 112 are embedded in a thermosetting resin 114. Unlike other laminates, which may be constructed by mixing together multiple types of carbon fibers (e.g., Toray's M40J with Toray's M60J), the carbon fibers 112 of the laminate 100 may all be of the same type of carbon fiber. For example, the carbon fibers 112 of the laminate 100 may all be Hexcel HexTow HM63 (“HM63”) carbon fibers, while the resin 114 the composite laminate 100 may be a Hexcel HexPly 996 resin (“996 resin”). The HM63 carbon fiber is a continuous, high strength, high performance, high modulus, polyacrylonitrile (PAN) based carbon fiber. The 996 resin is a 350° F. (177° C.) curing cyanate siloxane resin with a 330° F. (165° C.) glass transition temperature. The plies 110(1), 110(2), 110(N) may be co-cured using standard composite laminate curing techniques. The composite laminate 100 illustrated in FIG. 1A may contain a fiber volume of approximately 58-62%, which is a normal range for the fiber volume percentage for carbon fiber laminates. The fiber volume percentage is a volumetric percentage of the composite laminate that is fiber as opposed to resin. The fiber volume percentage may be measured by weight or by volume. Furthermore, each of the plies 110(1), 110(2), 110(N) of the composite laminate 100 may be either a unidirectional ply or a woven ply. Regardless of whether the plies 110(1), 110(2), 110(N) are unidirectional or woven plies, the plies 110(1), 110(2), 110(N) are stacked and oriented with respect to one another to create a quasi-isotropic composite laminate, such that the composite laminate 100 has isotropic properties in-plane. The composite laminate 100 may contains a positive coefficient of thermal expansion (CTE) (i.e., a CTE greater than 0).

The composite laminate 120, illustrated in FIG. 1B is composed of a plurality of carbon fiber plies 130(1)-130(N), where the carbon fibers 132 are embedded in a thermosetting resin 134. As previously explained, unlike other laminates, which may be constructed by mixing together multiple types of carbon fibers (e.g., Toray's M40J with Toray's M60J), the carbon fibers 132 of the laminate 120 may all be of the same type of carbon fiber. For example, similar to that of the composite laminate 100, the carbon fibers 132 of the laminate 120 may be HM63 carbon fibers, while the resin 134 the composite laminate 120 may be a 996 resin. The composite laminate 120 illustrated in FIG. 1B may contain a fiber volume percentage between 65% and 75%, and more preferably, a fiber volume percentage of approximately 69.3±1.0%. This fiber volume percentage is a high fiber volume percentage for carbon fiber laminates. Furthermore, like the composite laminate 100, each of the plies 130(1), 130(2), 130(N) of the composite laminate 120 may be either a unidirectional ply or a woven ply. The plies 130(1), 130(2), 130(N), regardless of whether or not they are unidirectional or woven plies, are stacked and oriented with respect to one another such that they create a quasi-isotropic composite laminate 120 (i.e., the composite laminate 120 has isotropic properties in-plane).

FIGS. 1C and 1D illustrate optical photomicrographs of quasi-isotropic composite laminates 100, 120. More specifically, both FIGS. 1C and 1D illustrate optical photomicrographs of composite laminates 100, 120 that are constructed with HM63 fibers and 996 resin, and are laid up in a [0/60/−60]s sequence. Furthermore, FIG. 1C illustrates an HM63 composite laminate 100 with an approximate fiber volume percentage of 62%. FIG. 1D illustrates an HM63 composite laminate 120 with an approximate fiber volume percentage of 69%. As illustrated in the difference between FIGS. 1A and 1B and the difference between FIGS. 1C and 1D, the carbon fibers 132 of the composite laminate 120 form a greater percentage of the composite laminate 120 than the carbon fibers 112 of the composite laminate 110. Because the composite laminate 120 has a higher fiber volume percentage compared to that of the composite laminate 100, the composite laminate 120 may contains a CTE that is zero or near zero (i.e., the composite laminate 120 does not expand or contract when experiencing temperature changes).

A zero CTE or near zero CTE quasi-isotropic composite laminate, like the composite laminate 120, may be created from carbon fiber plies, and more specifically, HM63/996 carbon fiber plies, via the process detailed below, where all of the carbon fiber plies are of a single type of carbon fiber (i.e., the composite laminate only contains one type of carbon fiber). As is understood, achieving zero CTE or near zero CTE for composite laminates constructed with carbon fiber typically results in blending multiple types of carbon fiber plies to balance the properties of one carbon fiber ply against the properties of another carbon fiber ply. However, the increase in the variety of available carbon fibers combined with the increase in the variety of available resins creates the opportunity to achieve zero CTE or near zero CTE composite laminates that are constructed with only a single type of carbon fiber embedded in a single resin by altering the fiber volume percentage of the carbon fibers. However, the fiber volume percentage is often difficult to acquire as each type of carbon fiber and each type of resin contains different mechanical properties (e.g., modulus of elasticity, tensile strength, in-plane shear strength, compressive strength, etc.). It is further understood that altering the fiber volume percentage alters the mechanical properties of a composite laminate. For example, adding too little fiber volume in the composite laminate will deteriorate some of the physical properties of the composite material, while adding too much fiber volume may decrease other physical properties of the composite material (e.g., the strength of the composite laminate due to the lack of space for the resin to fully surround and bond with the fibers). Thus, each combination of carbon fiber type and resin type is unique. Therefore, the process detailed below illustrates how to acquire a zero CTE or near zero CTE composite laminate constructed from a single type of carbon fiber plies while still achieving other desirable mechanical properties. Increasing the fiber volume beyond 65% is not typically performed/completed to modify the CTE of a composite laminate because it generally results in lower inter laminar shear strengths of the composite laminate. The use of resins like the 996 resin enables the fiber volume of a composite laminate to be increased to achieve a zero CTE or near zero CTE without degrading the interlaminar properties of the composite laminate below an acceptable value. Additionally, various resin-fiber systems will have a maximum practical fiber volume that can be achieved based on fiber packing density. Thus, it is not obvious that 69% fiber volume is manufacturable for all fibers and resin systems. Further, CTE properties are unique to the resin-fiber system. This invention developed the physical properties necessary to predict 0-CTE at 69% fiber volume, demonstrated the manufacturability of HM63/996 at 69%, and demonstrated that these 69% panels did have 0-CTE.

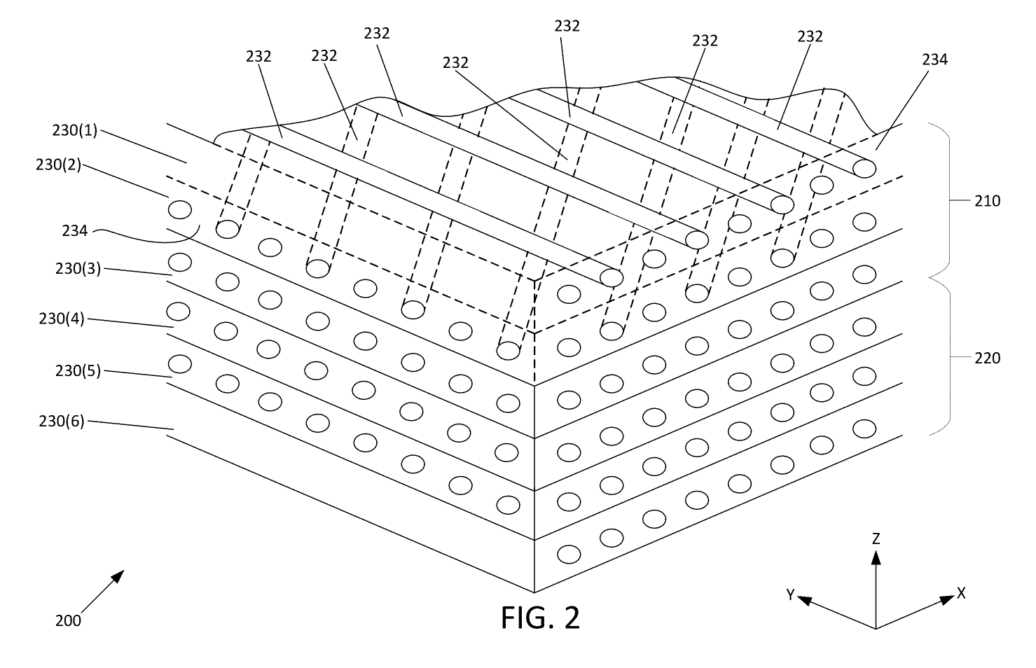

Turning to FIG. 2, illustrated is a schematic diagram illustrating the layup of a zero CTE or near zero CTE carbon fiber laminate 200 according to the present invention embodiment. In one embodiment, the carbon fiber laminate 200 may utilize a single type of carbon fiber and a singly type of resin, such as the HM63 carbon fibers and the 996 resin. While carbon fiber laminate 200 contains two groups 210, 220 of carbon reinforced layers, the zero CTE or near zero CTE carbon fiber laminate 200 may include fewer or more than two groups of carbon reinforced layers, where each carbon reinforced layer contains the same type of carbon fibers. As illustrated, the first carbon reinforced layer group 210 is constructed from three plies of 230(1), 230(2), 230(3) of carbon reinforced plies. As illustrated, and as similarly explained in FIG. 1A, plies 230(1), 230(2), 230(3) are constructed from HM63 carbon fibers 232 imbedded in the 996 resin 234. While the plies 230(1), 230(2), 230(3) are illustrated as being unidirectional plies, non-unidirectional or woven plies may be utilized for the carbon fiber laminate 200. In the embodiment illustrated in FIG. 2, the carbon fibers 232 of ply 230(1) may be parallel or offset 0 degrees from the principal material direction. Furthermore, the carbon fibers 232 of the ply 230(2) may be offset +60 degrees from the principal material direction, while the carbon fibers 232 of ply 230(3) may be offset −60 degrees from the principal material direction, where the principal material direction is the direction that is 0 degrees parallel to the Y-axis in the three-dimensional Cartesian coordinate system shown in FIG. 2.

Similar to the first carbon reinforced layer group 210, the second carbon reinforced layer group 220 is constructed from three plies of 230(4), 230(5), 230(6) of carbon reinforced plies. Plies 230(4), 230(5), 230(6), similar to that of plies 230(1), 230(2), 230(3) are constructed from HM63 carbon fibers 232 imbedded in the 996 resin 234. In addition, the plies 230(4), 230(5), 230(6) of the second carbon reinforced layer group 220 are laid up in a symmetrical orientation to those of the plies 230(1), 230(2), 230(3) of the first carbon reinforced layer group 210. Thus, the carbon fibers 232 of ply 230(4) may be offset −60 degrees from the principal material direction, while the carbon fibers 232 of ply 230(5) may be offset +60 degrees from the principal material direction. Furthermore, the carbon fibers 232 of ply 230(6) may be parallel or offset 0 degrees from the principal material direction.

In other layups of the zero CTE and near zero CTE carbon fiber laminate 200, unidirectional plies may be layered in a multitude of orientations such that the number of angles used must divide a circle into equal parts. For example, the first carbon reinforced layer group may include a first carbon fiber ply where the carbon fibers are parallel to the principal material direction, a second carbon fiber ply where the carbon fibers are perpendicular to the principal material direction, a third carbon fiber ply where the carbon fibers are +45 degrees with respect to the principal material direction, and a fourth carbon fiber ply where the carbon fibers are −45 degrees with respect to the principal material direction. Furthermore, additional layers may be arranged in either a symmetrical layup around a midplane or non-symmetrical layup.

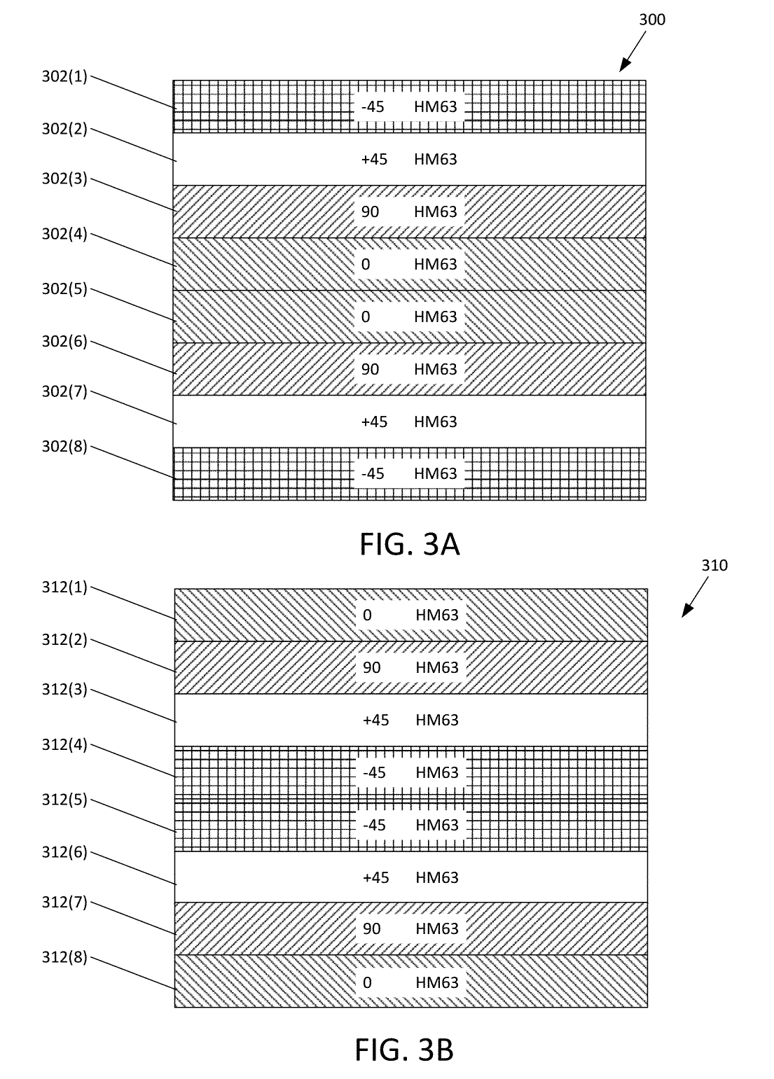

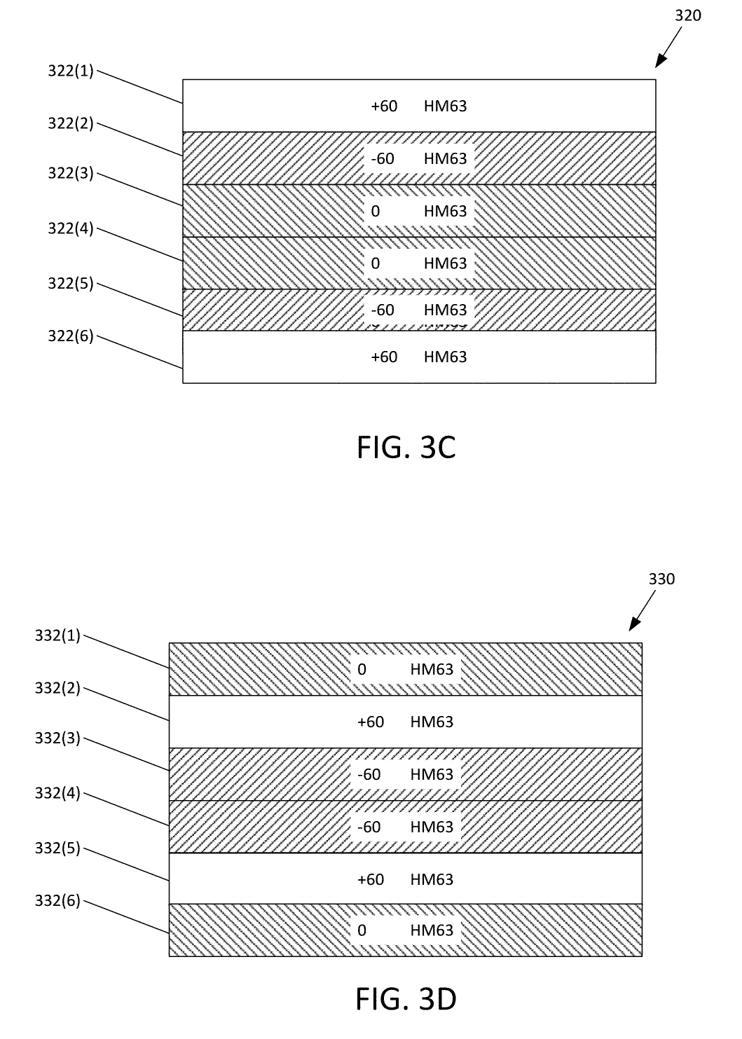

FIG. 3A further illustrates a schematic cross-sectional view of a first embodiment of the symmetrical layup of the zero-CTE carbon fiber laminate 300. While the laminate 300 illustrated in FIG. 3A contains eight plies 302(1)-302(8) oriented in a symmetrical layup, as previously explained, any number of plies may be used to construct the zero-CTE carbon fiber laminate 300. As illustrated, the first and eighth plies 302(1), 302(8) contain fibers oriented at an angle that is −45 degrees to the principal material direction, while the second and seventh plies 302(2), 302(7) contains fibers oriented at an angle that is +45 degrees to the principal material direction. Furthermore, the third and sixth plies 302(3), 302(6) contain fibers oriented at an angle that is 90 degrees (or perpendicular) to the principal material direction, while the fourth and fifth plies 302(4), 302(5) contain fibers oriented at an angle that is 0 degrees (or parallel) to the principal material direction. As illustrated in FIG. 3A, the orientation angles of the HM63 carbon fiber plies 302(1)-302(8) of the composite laminate 300 represents a quasi-isotropic laminate, which has material properties that are equal in two orthogonal directions: 0 degrees and 90 degrees.

FIG. 3B further illustrates a schematic cross-sectional view of a second embodiment of the symmetrical layup of the zero-CTE carbon fiber laminate 310. While the laminate 310 illustrated in FIG. 3B contains eight plies 312(1)-312(8) oriented in a symmetrical layup, as previously explained, any number of plies may be used to construct the zero-CTE carbon fiber laminate 310. As illustrated, the first and eighth plies 312(1), 312(8) contain fibers oriented at an angle that is 0 degrees (or parallel) to the principal material direction, while the second and seventh plies 312(2), 312(7) contains fibers oriented at an angle that is 90 degrees (or perpendicular) to the principal material direction. Furthermore, the third and sixth plies 312(3), 312(6) contain fibers oriented at an angle that is +45 degrees to the principal material direction, while the fourth and fifth plies 312(4), 312(5) contain fibers oriented at an angle that is −45 degrees to the principal material direction. The orientation angles of the HM63 carbon fiber plies 312(1)-312(8) of the composite laminate 310 illustrated in FIG. 3B represents a quasi-isotropic laminate that has material properties that are equal in two orthogonal directions: 0 degrees and 90 degrees.

FIG. 3C further illustrates a schematic cross-sectional view of a third embodiment of the symmetrical layup of the zero-CTE carbon fiber laminate 320. While the laminate 320 illustrated in FIG. 3C contains six plies 322(1)-322(6) oriented in a symmetrical layup, as previously explained, any number of plies may be used to construct the zero-CTE carbon fiber laminate 320. As illustrated, the first and sixth plies 322(1), 322(6) contain fibers oriented at an angle that is +60 degrees to the principal material direction, while the second and fifth plies 322(2), 322(5) contains fibers oriented at an angle that is −60 degrees to the principal material direction. Additionally, the third and fourth plies 322(3), 322(4) contain fibers oriented at an angle that is 0 degrees (or parallel) to the principal material direction. The orientation angles of the HM63 carbon fiber plies 322(1)-322(6) of the composite laminate 320 illustrated in FIG. 3C represents a quasi-isotropic laminate that has material properties that are equal in two orthogonal directions: 0 degrees and 90 degrees.

FIG. 3D further illustrates a schematic cross-sectional view of a fourth embodiment of the symmetrical layup of the zero-CTE carbon fiber laminate 330. While the laminate 330 illustrated in FIG. 3D contains six plies 332(1)-332(6) oriented in a symmetrical layup, as previously explained, any number of plies may be used to construct the zero-CTE carbon fiber laminate 330. As illustrated, the first and sixth plies 332(1), 332(6) contain fibers oriented at an angle that is 0 degrees (or parallel) to the principal material direction, while the second and fifth plies 332(2), 332(5) contains fibers oriented at an angle that is +60 degrees to the principal material direction. Additionally, the third and fourth plies 332(3), 332(4) contain fibers oriented at an angle that is −60 degrees to the principal material direction. The orientation angles of the HM63 carbon fiber plies 332(1)-332(6) of the composite laminate 330 illustrated in FIG. 3D represents a quasi-isotropic laminate that has material properties that are equal in two orthogonal directions: 0 degrees and 90 degrees.

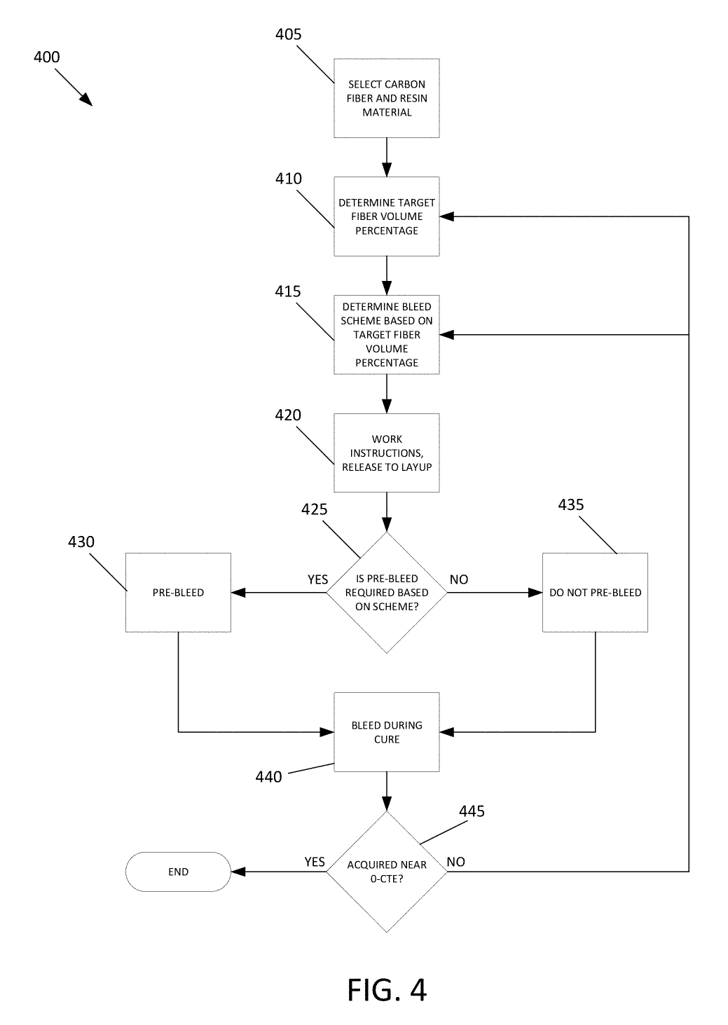

Turning to FIG. 4, illustrated is a process 400 for increasing the fiber volume percentage of a single type of carbon fiber composite material to achieve zero CTE or near zero CTE of a composite laminate. According to the process 400, initially, at step 405, the carbon fiber and the resin material are selected. In one embodiment of the carbon fiber composite laminate, the carbon fiber chosen is the HM63 carbon fiber, and the resin chosen is the 996 resin. Furthermore, the chosen materials may be a prepreg material (i.e., a fibrous material preimpregnated with a particular synthetic resin), such as HM63 carbon fibers preimpregnated with the 996 resin. Essentially, a prepreg material may be created by taking aligned fibers and pressing them together with a resin film via hot presses to create flat layers that can be stacked on top of one another for processing. HM63/996 is only one example of a suitable prepreg material, and other material/resin prepreg combinations may be used, including but not limited to, Toray's M55J/954-6, Toray's M40J/996, Toray's M60J/996

Next, at step 410, a target fiber volume percentage is chosen based on the materials chosen in step 405. For example, when using prepreg materials, the fiber volume percentage of the preimpregnated materials may be known, especially when the prepreg materials are subject to traditional composite laminate curing techniques. In addition, the CTE values of the materials chosen in step 405 may be known, especially when the chosen materials are cured using standard composite laminate curing techniques. The target fiber volume percentage may be determined based on these known values.

At step 415, a bleed scheme is determined based on the target fiber volume percentage established at step 410. The bleed scheme is the process in which the resin is pulled from the carbon fiber layup to increase the fiber volume percentage of the carbon fiber in the composite laminate. The bleed scheme is calculated by taking the incoming prepreg properties and determining the amount of resin that needs to be removed to achieve the desired fiber volume. This is done by understanding how much resin will bleed into Teflon coated fiberglass layers that are used to preferentially remove enough resin to get to the desired fiber volume to achieve zero or near zero CTE. This is based on historical data specific to the fiber-resin system, and may require several design iterations. A bleed scheme could include a pre-bleed process and/or a bleed during cure process. For example, for HM63/996 prepregs, where the fiber to resin ratio is known, the amount of resin that needs to be bled from the layup can be determined to achieve the target fiber volume percentage. At step 420, the materials are combined in a composite layup. The carbon fiber plies may be stacked on top of one another in an orientation to achieve a quasi-isotropic composite laminate, like that illustrated in FIGS. 2 and 3. Furthermore, the layup is then bagged, and placed in an autoclave. At step 425, it is determined whether a pre-bleed of the layup is required based on the bleed scheme determined in step 415. A pre-bleed process is pulling vacuum on the bagged layup when the material is disposed next to a porous material so that resin may be pulled off and the fiber volume is increased. The pre-bleed process may occur within the autoclave, but at a reduced temperature and pressure compared to that of a typical cure process. If at step 425, it is determined that a pre-bleed process should occur according to the determined bleed scheme, then, at step 430, the pre-bleed process is performed. However, if at step 425, it is determined that a pre-bleed process should not occur in accordance with the determined bleed scheme, then, at step 435, the pre-bleed process is not performed.

At step 440, the cure process is performed while bleeding the resin from the layup during the cure process. The curing process of the bagged layup disposed within an autoclave subjects the bagged layup to an elevated pressure and temperature, which, when combined with the vacuum imparted onto the bagged layup within the autoclave, causes the resin to distribute evenly through the layup. Moreover, when the layup is bagged with a porous material, the resin may be bled during the cure process (i.e., the porous material enables amounts of resin to be pulled from the layup during the cure process). If the layup was subject to a pre-bleed at step 430, the bleed during cure process, at step 440, pulls additional amounts of resin from the layup. However, resin may be first pulled from the layup during the cure process, at step 440, if the layup was not subject to a pre-bleed at step 435. The amount of resin bled from the layup during the cure process may be determined by the thickness of the porous material and the kinetics of the cure process.

At step 445, once the cure process is complete, the properties of the composite material are tested to determine if the composite laminate has acquired a zero or near zero CTE while still maintaining other desirable mechanical properties. If, at 445, the composite material did not achieve zero or near zero CTE, then the process 400 returns to steps 410 and 415 to alter the target fiber volume percentage and/or the bleed scheme. If the composite laminate did not achieve zero or near zero CTE, then the target fiber volume may need to be increased or decreased at step 410. Furthermore, if the composite laminate did not achieve zero or near zero CTE, the bleed scheme could be altered, especially if the composite laminate did not achieve the target fiber volume previously determined at step 410. If, at 445, the composite material did achieve zero or near zero CTE, and the mechanical properties are sufficient for the laminate's intended purpose, then the process 400 ends.

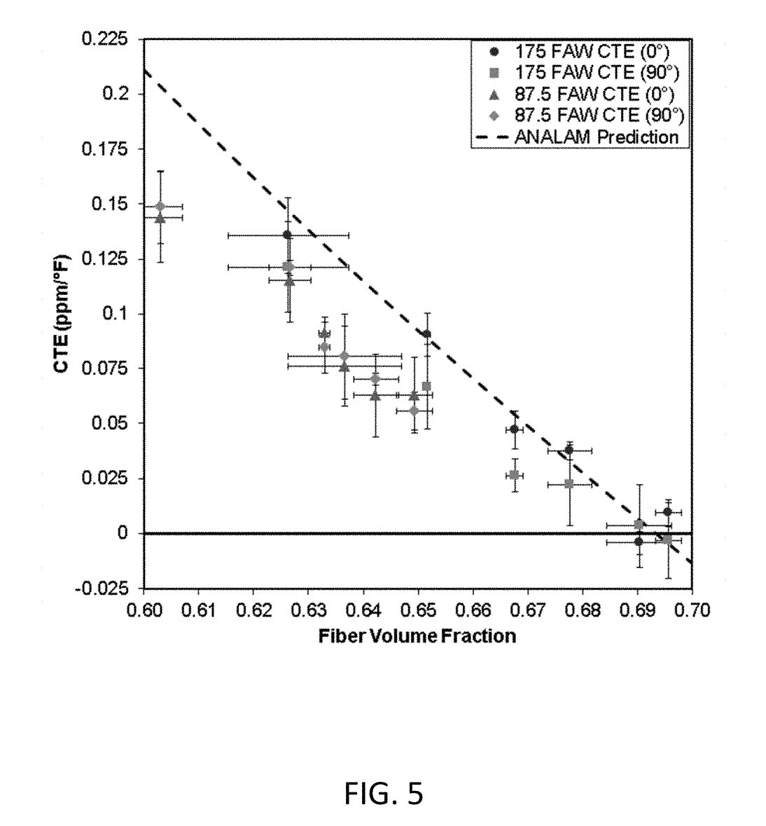

FIG. 5 illustrates the various test results or iterations of the process 400 illustrated in FIG. 4 for two composite laminates of HM63 carbon fibers embedded within the 996 resin (i.e., HM63/996 prepregs). As illustrated, the HM63/996 prepregs were tested at two different fiber areal weights (“FAW”) (i.e., the thickness of the plies). For all samples, the prepreg plies were laid up in a quasi-isotropic, [0/60/−60]s ply stacking sequence. For each FAW composite laminate created, the CTE was tested in both a direction with a 0 degree offset with respect to the principal material direction and a direction with a 90 degree offset with respect to the principal material direction. As illustrated, with respect to the higher FAW HM63/996 composite laminates, regardless of the direction/orientation tested, as the fiber volume percentage is increased, the CTE of the composite laminate decreases towards zero. For the HM63/996 prepreg, it was predicted that 69.3±1.0% fiber volume of would achieve zero-CTE properties. Through various iterations of the process 400, multiple layups and bleed schemes (i.e., pre-bleeds and/or bleeds during cure) were tested to determine how to achieve a 69.3±1.0% fiber volume and a zero or near zero CTE. As illustrated in the graph of FIG. 5, the process 400 confirmed that, as the fiber volume was increased, the CTE of the composite laminate approached zero or near zero CTE. For example, as illustrated in the graph of FIG. 5, increasing the carbon fiber volume for an HM63/996 prepreg to approximately 66.0% achieved a CTE that is approximately 0.5 parts per million per degree Fahrenheit (ppm/° F.), while increasing the carbon fiber volume percentage to approximately 68.0% achieved a CTE that is approximately 0.25 parts per million per degree Fahrenheit (ppm/° F.). As further illustrated in the graph of FIG. 5, the process 400 also confirmed that, for an HM63/996 prepreg, a carbon fiber volume percentage of 69.3±1.0% achieves a CTE that is 0.00±0.04 parts per million per degree Fahrenheit (ppm/° F.). Thus, the HM63/996 composite laminates created with a 0.00±0.04 ppm/° F. CTE, which is achieved by increasing the fiber volume percentage to approximately 69.3±1.0%, are viable for a wide variety of applications within precision space structures, optical benches, etc.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. A composite laminate comprising:
a first ply of unidirectional carbon fibers, the first carbon fiber ply being oriented at a first angle with respect to a reference direction; and
a second ply of unidirectional carbon fibers, the second carbon fiber ply being oriented at a second angle with respect to a reference direction, the second angle being different from the first angle,
wherein the carbon fibers of the first ply and the carbon fibers of the second ply are embedded in a resin, and wherein the composite laminate has a fiber volume percentage greater than 62% and a substantially zero coefficient of thermal expansion.

2. The composite laminate according to claim 1, wherein the carbon fibers of the first ply and the carbon fibers of the second ply are HM63.

3. The composite laminate according to claim 2, wherein the resin is a 996 cyanate siloxane resin.

4. The composite laminate according to claim 3, wherein the fiber volume percentage is between 65% and 75%.

5. The composite laminate according to claim 4, wherein the fiber volume percentage is between 68.3% and 70.3%.

6. The composite laminate according to claim 1, wherein the coefficient of thermal expansion is between 0.04 parts per million per degree Fahrenheit and −0.04 parts per million per degree Fahrenheit.

7. The composite laminate according to claim 1, wherein the composite laminate is quasi-isotropic.

8. The composite laminate according to claim 1, wherein the carbon fibers of the first ply are of a first type, and the carbon fibers of the second ply are of a second type, the first type being the same as the second type.

9. The composite laminate according to claim 1, wherein the first carbon fiber ply is oriented parallel to the reference direction, and the second carbon fiber ply is oriented +60° from the reference direction, and further comprising:
a third carbon fiber ply that is oriented −60° from the reference direction.

10. The composite laminate according to claim 1, wherein the first carbon fiber ply is oriented parallel to the reference direction, and the second carbon fiber ply is oriented perpendicular to the reference direction, and further comprising:
a third carbon fiber ply that is oriented +45° from the reference direction; and
a fourth carbon fiber ply that is oriented −45° from the reference direction.

11. A method for acquiring a substantially zero coefficient of thermal expansion for a composite laminate comprising:
setting a target fiber volume percentage;
determining a bleed scheme for the composite laminate based on the target fiber volume percentage and materials chosen for the composite laminate;
curing the composite laminate based on the bleed scheme; and
testing the composite laminate to calculate the coefficient of thermal expansion.

12. The method of claim 11, wherein determining the bleed scheme further comprises:
determining whether a pre-bleed is required based on the target fiber volume percentage and the materials chosen for the composite laminate.

13. The method of claim 12, wherein determining the bleed scheme further comprises:
determining whether a bleed during cure is required based on the target fiber volume percentage and the materials chosen for the composite laminate.

14. The method of claim 11, wherein setting the target fiber volume percentage is setting a first target fiber volume, the method further comprising:
if the calculated coefficient of thermal expansion is not substantially zero, setting a second target fiber volume based on the calculated coefficient of thermal expansion of the composite laminate.

15. The method of claim 14, further comprising:
if the calculated coefficient of thermal expansion is not substantially zero, modifying the bleed scheme based on the target fiber volume percentage, materials chosen for the composite laminate, and the calculated coefficient of thermal expansion of the composite laminate.

16. The method of claim 11, wherein the target fiber volume percentage is greater than 62%, and preferably between 68.3%. and 70.3%.

17. A composite laminate comprising:
a plurality of carbon fiber plies that each include unidirectional carbon fibers oriented at ±Theta with respect to a reference direction, the carbon fibers being embedded in a resin, wherein the composite laminate has a fiber volume percentage greater than 62% and a substantially zero coefficient of thermal expansion.

18. The composite laminate according to claim 17, wherein the carbon fibers are HM63.

19. The composite laminate according to claim 17, wherein the resin is a 996 cyanate siloxane resin.

20. The composite laminate according to claim 17, wherein the coefficient of thermal expansion is between 0.04 parts per million per degree Fahrenheit and −0.04 parts per million per degree Fahrenheit.
